(19) United States
(12) Patent Application Publication
(10) Pub. No.: US 2016/0184699 A1
(43) Pub. Date: Jun. 30, 2016

(54) DISPLAY AND NAVIGATION OF VIRTUAL BUILT ENVIRONMENTS IN COMPUTER-IMPLEMENTED GAMES

(71) Applicant: Zynga Inc., (US)

(72) Inventors: Ibrahim Nabil Rageh, Pleasant Hill, CA (US); Jason Pyke, Oakland, CA (US)

(73) Assignee: Zynga Inc., San Francisco, CA (US)

(21) Appl. No.: 13/692,085

(22) Filed: Dec. 3, 2012

(51) Int. Cl. A63F 13/00

(52) U.S. Cl. CPC A63F 13/00

(57) ABSTRACT

A method and system provides a multiplayer computer-implemented game in which a game instance defines a virtual world comprising a building displayed to a user in a game display which can be switched between an overview comprising a side on, elevational view of the building in which the interiors of multiple rooms that together define the house are simultaneously visible, and a close-up side on view of a selected room. At least the close-up view may provide a three-dimensional interactive space that is accessible to one or more player characters controlled by users, to allow movement laterally across a screen on which the game display is provided, and into a depth dimension relative to the user's view.

### DISCLAIMER

Portions of this disclosure contain material that is subject to copyright protection. The copyright owner has no objection to the facsimile reproduction by anyone of the patent document or the patent disclosure, as it appears in the Patent and Trademark Office patent files or records, but otherwise reserves all copyright rights whatsoever. The following notice applies to the software and data as described below and in the drawings that form a part of this document: Copyright Zynga Inc. All Rights Reserved.

### BACKGROUND

In many online computer games, there is a virtual world or some other imagined playing space where a player of the game controls one or more player characters (herein “characters,” “player characters,” or “PCs”). Player characters can be considered in-game representations of the controlling player. As used herein, the terms player, user, entity, neighbor, friend, and the like may refer to the in-game player character controlled by that player, user, entity, or friend, unless context suggests otherwise. A game display can display a representation of the player character. A game engine accepts inputs from the player, determines player character actions, decides outcomes of events, and presents the player with a game display illuminating game play. In some games, there are multiple players, wherein each player controls one or more player characters.

An electronic social networking system typically operates with one or more social networking servers providing interaction between users such that a user can specify other users of the social networking system as “friends.” A collection of users and the “friend” connections between users can form a social graph in such a social networking system that can be traversed to find second, third and more remote connections between users, much like a graph of nodes connected by edges can be traversed. Instead or in addition, an in-game social graph may be maintained.

Many online computer games are operated on an online social network. Such a network allows both users and other parties to interact with the computer games directly, whether to play the games or to retrieve game- or user-related information. Internet users may maintain one or more accounts with various service providers, including, for example, online game networking systems and online social networking systems. Online systems can typically be accessed using browser clients (e.g., Firefox, Chrome, Internet Explorer).

A virtual world in which game play occurs can often be populated by multiple claim elements (such as in-game objects and other player characters) in screen space which is necessarily limited. This can complicate intuitive gameplay during navigation of player characters through the virtual world, resulting in game displays that do not have a natural look and feel. Such complications are amplified for game displays that are provided on mobile devices.

### BRIEF DESCRIPTION OF THE DRAWINGS

FIG. 1 illustrates an example of a system for implementing particular disclosed embodiments.

FIG. 2 illustrates an example social network.

FIG. 3 illustrates an example system for implementing particular disclosed embodiments.

FIG. 4 illustrates an example method for implementing particular disclosed embodiments.

FIG. 5 illustrates an example game display in accordance with a particular disclosed embodiment, showing an overview of a virtual world for a game instance of a multiplayer game.

FIGS. 6A-6F in the strict respective example game displays in accordance with particular disclosed embodiments, showing close-up views of one or more rooms forming part of a virtual world for game instance of a multiplayer game.

FIG. 7 illustrates a mobile electronic device on which a game display may be provided in accordance with an example embodiment.

FIG. 8 illustrates an example data flow in a system.

FIG. 9 illustrates an example network environment.

FIG. 10 illustrates an example computer system architecture.

### DESCRIPTION OF EXAMPLE EMBODIMENTS

Some example embodiments described herein disclose methods and systems to provide a multiplayer computer-implemented game in which a game instance defines a virtual world comprising a building, such as a house, displayed to a user in a game display which can be switched between an overview comprising a side on, elevational view of the building in which the interiors of multiple rooms that together define the house are simultaneously visible, and a close-up side view of a selected room.

At least the close-up view may provide a three-dimensional interactive space that is accessible to one or more player characters controlled by users, to allow movement laterally across a screen on which the game display is provided, and into a depth dimension relative to the user's view. In some embodiments, such three-dimensional movement is instead, or in addition, possible in the overview.

The virtual building may be limited such that it is a single layer deep, regardless of the number and type of rooms that are added by a player during gameplay, with all of the rooms having a common front wall that is shown as being transparent, peeled away, or omitted, so that the overview comprises a dollhouse-type review, seen in a horizontal direction.

The close-up view of the selected room may be seen from a camera position that is at a fixed position at or close to the invisible front wall, with camera focus being shifted between parts of the room, characters or objects in the room, by apparent horizontal and/or vertical swiveling movement of camera direction at the fixed camera position.

These and further aspects of the example embodiment will be evident from the description that follows. An example game environment for implementing example embodiments is first described, whereafter example embodiment is described in greater specificity, in the context of the example game environment.

### Example Game Environment

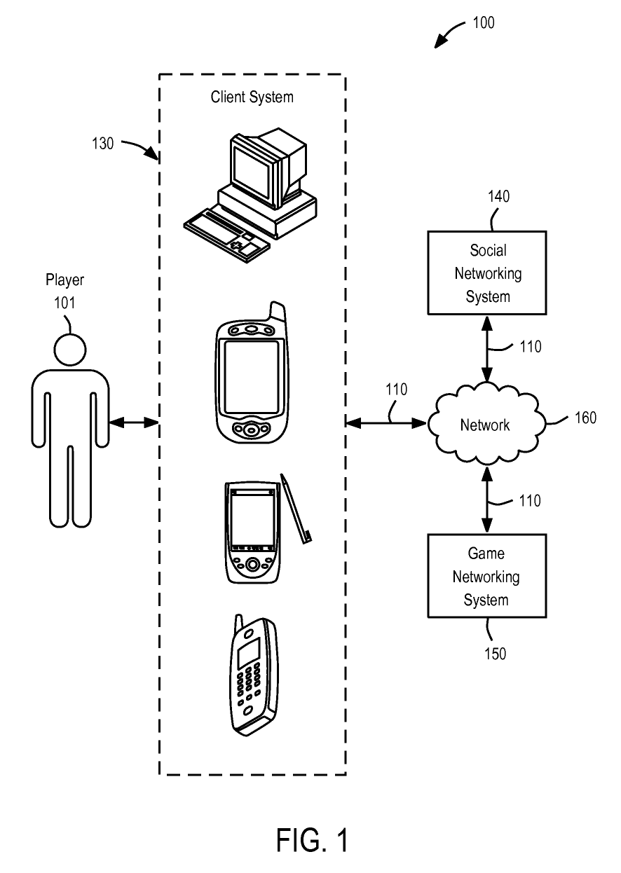

FIG. 1 illustrates an example of a system 100 for implementing various disclosed embodiments. In particular embodiments, system 100 comprises player 101, social networking system 140, game networking system 150, client system 130, and network 160. The components of system 100 can be connected to each other in any suitable configuration, using any suitable type of connection. The components may be connected directly or over a network 160, which may be any suitable network. For example, one or more portions of network 160 may be an ad hoc network, an intranet, an extranet, a virtual private network (VPN), a local area network (LAN), a wireless LAN (WLAN), a wide area network (WAN), a wireless WAN (WWAN), a metropolitan area network (MAN), a portion of the Internet, a portion of the Public Switched Telephone Network (PSTN), a cellular telephone network, another type of network, or a combination of two or more such networks.

Social networking system 140 is a network-addressable computing system that can host one or more social graphs. Social networking system 140 can generate, store, receive, and transmit social networking data. Social networking system 140 can be accessed by the other components of system 100 either directly or via network 160. Game networking system 150 is a network-addressable computing system that can host one or more online games. Game networking system 150 can generate, store, receive, and transmit game-related data, such as, for example, game account data, game input, game state data, and game displays. Game networking system 150 can be accessed by the other components of system 100 either directly or via network 160. Player 101 may use client system 130 to access, send data to, and receive data from social networking system 140 and game networking system 150. Client system 130 can access social networking system 120 or game networking system 150 directly, via network 160, or via a third-party system. As an example and not by way of limitation, client system 130 may access game networking system 150 via social networking system 140. Client system 130 can be any suitable computing device, such as a personal computer, laptop, cellular phone, smart phone, computing tablet, or the like.

Although FIG. 1 illustrates a particular number of players 101, social networking systems 140, game networking systems 150, client systems 130, and networks 160, this disclosure contemplates any suitable number of players 101, social networking systems 140, game networking systems 150, client systems 130, and networks 160. As an example and not by way of limitation, system 100 may include one or more game networking systems 150 and no social networking systems 140. As another example and not by way of limitation, system 100 may include a system that comprises both social networking system 140 and game networking system 150. Moreover, although FIG. 1 illustrates a particular arrangement of player 101, social networking system 140, game networking system 150, client system 130, and network 160, this disclosure contemplates any suitable arrangement of player 101, social networking system 140, game networking system 150, client system 130, and network 160.

The components of system 100 may be connected to each other using any suitable connections 110. For example, suitable connections 110 include wireline (such as, for example, digital subscriber line (DSL) or Data Over Cable Service Interface Specification (DOCSIS)), wireless (such as, for example, Wi-Fi or Worldwide Interoperability for Microwave Access (WiMAX)) or optical (such as, for example, Synchronous Optical Network (SONET) or Synchronous Digital Hierarchy (SDH)) connections. In particular embodiments, one or more connections 110 each include an ad hoc network, an intranet, an extranet, a VPN, a LAN, a WLAN, a WAN, a WWAN, a MAN, a portion of the Internet, a portion of the PSTN, a cellular telephone network, another type of connection, or a combination of two or more such connections. Connections 110 need not necessarily be the same throughout system 100. One or more first connections 110 may differ in one or more respects from one or more second connections 110. Although FIG. 1 illustrates particular connections between player 101, social networking system 140, game networking system 150, client system 130, and network 160, this disclosure contemplates any suitable connections between player 101, social networking system 140, game networking system 150, client system 130, and network 160. As an example and not by way of limitation, in particular embodiments, client system 130 may have a direct connection to social networking system 140 or game networking system 150, bypassing network 160.

### Game Networking Systems

In an online computer game, a game engine manages the game state of the game. A game state comprises all game play parameters, including player character state, non-player character (NPC) state, in-game object state, game world state (e.g., internal game clocks, game environment), and other game play parameters. Each player 101 controls one or more player characters (PCs). The game engine controls all other aspects of the game, including non-player characters (NPCs) and in-game objects. The game engine also manages game state, including player character state for currently active (online) and inactive (offline) players.

An online game can be hosted by game networking system 150, which can be accessed using any suitable connection with a suitable client system 130. A player may have a game account on game networking system 150, wherein the game account can contain a variety of information associated with the player (e.g., the player's personal information, financial information, purchase history, player character state, and game state). In some embodiments, a player may play multiple games on game networking system 150, which may maintain a single game account for the player with respect to all the games, or multiple individual game accounts for each game with respect to the player. In some embodiments, game networking system 150 can assign a unique identifier to each player 101 of an online game hosted on game networking system 150. Game networking system 150 can determine that a player 101 is accessing the online game by reading the user's cookies, which may be appended to Hypertext Transfer Protocol (HTTP) requests transmitted by client system 130, and/or by the player 101 logging onto the online game.

In particular embodiments, player 101 may access an online game and control the game's progress via client system 130 (e.g., by inputting commands to the game at the client device). Client system 130 can display the game interface, receive inputs from player 101, transmit user inputs or other events to the game engine, and receive instructions from the game engine. The game engine can be executed on any suitable system (such as, for example, client system 130, social networking system 140, or game networking system 150). As an example and not by way of limitation, client system 130 can download client components of an online game, which are executed locally, while a remote game server, such as game networking system 150, provides backend support for the client components and may be responsible for maintaining application data of the game, processing the inputs from the player, updating and/or synchronizing the game state based on the game logic and each input from the player, and transmitting instructions to client system 130. As another example and not by way of limitation, each time player 101 provides an input to the game through the client system 130 (such as, for example, by typing on the keyboard or clicking the mouse of client system 130), the client components of the game may transmit the player's input to game networking system 150.

### Game Play

In particular embodiments, player 101 can engage in, or cause a player character controlled by him to engage in, one or more in-game actions. For a particular game, various types of in-game actions may be available to player 101. As an example and not by way of limitation, a player character in an online role-playing game may be able to interact with other player characters, build a virtual house, decorate the interior of a virtual house, attack enemies, go on a quest, and go to a virtual store to buy/sell virtual items. As another example and not by way of limitation, a player character in an online poker game may be able to play at specific tables, place bets of virtual or legal currency for certain amounts, discard or hold certain cards, play or fold certain hands, and play in a online poker tournament.

In particular embodiments, player 101 may engage in an in-game action by providing one or more user inputs to client system 130. Various actions may require various types and numbers of user inputs. Some types of in-game actions may require a single user input. As an example and not by way of limitation, player 101 may be able to harvest a virtual crop by clicking on it once with a mouse. Some types of in-game actions may require multiple user inputs. As another example and not by way of limitation, player 101 may be able to throw a virtual fireball at an in-game object by entering the following sequence on a keyboard: DOWN, DOWN and RIGHT, RIGHT, B. This disclosure contemplates engaging in in-game actions using any suitable number and type of user inputs.

In particular embodiments, player 101 can perform an in-game action on an in-game object or with respect to another player character. In-game actions performed with respect to another player character comprise “social interactions” as used herein. Actions performed with respect to non-player characters are not considered social interactions. An in-game object is any interactive element of an online game. In-game objects may include, for example, player characters, NPCs, in-game assets and other virtual items, in-game obstacles, game elements, game features, and other in-game objects. This disclosure contemplates performing in-game actions on any suitable in-game objects. For a particular in-game object, various types of in-game actions may be available to player 101 based on the type of in-game object. As an example and not by way of limitation, if player 101 encounters a virtual bear, the game engine may give him the options of shooting the bear or petting the bear. Some in-game actions may be available for particular types of in-game objects but not other types. As an example and not by way of limitation, if player 101 encounters a virtual rock, the game engine may give him the option of moving the rock; however, unlike the virtual bear, the game engine may not allow player 101 to shoot or pet the virtual rock. Furthermore, for a particular in-game object, various types of in-game actions may be available to player 101 based on the game state of the in-game object. As an example and not by way of limitation, if player 101 encounters a virtual crop that was recently planted, the game engine may give him only the option of fertilizing the crop, but if player 101 returns to the virtual crop later when it is fully grown, the game engine may give him only the option of harvesting the crop.

In particular embodiments, the game engine may cause one or more game events to occur in the game. Game events may include, for example, a change in game state, an outcome of an engagement, completion of an in-game obstacle, a transfer of an in-game asset or other virtual item, or a provision of access, rights and/or benefits. In particular embodiments, a game event is any change in game state. Similarly, any change in game state may be a game event. As an example and not by way of limitation, the game engine may cause a game event where the virtual world cycles between daytime and nighttime every 24 hours. As another example and not by way of limitation, the game engine may cause a game event where a new instance, level, or area of the game becomes available to player 101. As yet another example and not by way of limitation, the game engine may cause a game event where player 101's player character heals one hit point every 5 minutes. Game events may include asynchronous social events, as described in greater detail herein.

In particular embodiments, a game event or change in game state may be an outcome of one or more in-game actions. The game engine can determine the outcome of a game event or a change in game state according to a variety of factors, such as, for example, game logic or rules, player character in-game actions, player character state, game state of one or more in-game objects, interactions of other player characters, or random calculations. As an example and not by way of limitation, player 101 may overcome an in-game obstacle and earn sufficient experience points to advance to the next level, thereby changing the game state of player 101's player character (it advances to the next character level). As another example and not by way of limitation, player 101 may defeat a particular boss NPC in a game instance, thereby causing a game event where the game instance is completed, and the player advances to a new game instance. As yet another example and not by way of limitation, player 101 may pick the lock on a virtual door to open it, thereby changing the game state of the door (it goes from closed to open) and causing a game event (the player can access a new area of the game).

In particular embodiments, player 101 may access particular game instances of an online game. A game instance is a copy of a specific game play area that is created during runtime. In particular embodiments, a game instance is a discrete game play area where one or more players 101 can interact in synchronous or asynchronous play. A game instance may be, for example, a level, zone, area, region, location, virtual space, or other suitable play area. A game instance may be populated by one or more in-game objects. Each object may be defined within the game instance by one or more variables, such as, for example, position, height, width, depth, direction, time, duration, speed, color, and other suitable variables. A game instance may be exclusive (i.e., accessible by specific players) or non-exclusive (i.e., accessible by any player). In particular embodiments, a game instance is populated by one or more player characters controlled by one or more players 101 and one or more in-game objects controlled by the game engine. When accessing an online game, the game engine may allow player 101 to select a particular game instance to play from a plurality of game instances. Alternatively, the game engine may automatically select the game instance that player 101 will access. In particular embodiments, an online game comprises only one game instance that all players 101 of the online game can access.

In particular embodiments, a specific game instance may be associated with one or more specific players. A game instance is associated with a specific player when one or more game parameters of the game instance are associated with the specific player. As an example and not by way of limitation, a game instance associated with a first player may be named “First player's Play Area,” or “First player's Game Instance.” This game instance may be populated with the first player's player character and one or more in-game objects associated with the first player.

Such a game instance associated with a specific player may be accessible by one or more other players, either synchronously or asynchronously with the specific player's game play. As an example and not by way of limitation, a first player (i.e., the host player) may be associated with a first game instance, but the first game instance may be accessed by all first-degree friends in the first player's social network. As used herein, players thus accessing a game instance associated with another player are referred to as guest players, guests, visiting players, or visitors. In particular embodiments, the game engine may create a specific game instance for a specific player when that player accesses the game. As an example and not by way of limitation, the game engine may create a first game instance when a first player initially accesses an online game, and that same game instance may be loaded each time the first player accesses the game.

In particular embodiments, the set of in-game actions available to a specific player may be different in a game instance that is associated with that player (e.g., in which the player is a host player) compared to a game instance that is not associated with that player (e.g., in which the player is a guest player). The set of in-game actions available to a specific player in a game instance associated with that player may be a subset, superset, or independent of the set of in-game actions available to that player in a game instance that is not associated with him. As an example and not by way of limitation, a first player may be associated with Blackacre Farm in an online farming game. The first player may be able to plant crops on Blackacre Farm. If the first player accesses a game instance associated with another player, such as Whiteacre Farm, the game engine may not allow the first player to plant crops in that game instance. However, other in-game actions may be available to the first player, such as watering or fertilizing crops on Whiteacre Farm.

### Social Graphs and Social Networking Systems

In particular embodiments, a game engine can interface with a social graph. Social graphs are models of connections between entities (e.g., individuals, users, contacts, friends, players, player characters, non-player characters, businesses, groups, associations, concepts, etc.). These entities are considered “users” of the social graph; as such, the terms “entity” and “user” may be used interchangeably when referring to social graphs herein. A social graph can have a node for each entity and edges to represent relationships between entities. A node in a social graph can represent any entity. In particular embodiments, a unique client identifier can be assigned to each user in the social graph. This disclosure assumes that at least one entity of a social graph is a player or player character in an online multiplayer game, though this disclosure may apply to any suitable social graph user.

The minimum number of edges to connect a player (or player character) to another user is considered the degree of separation between them. For example, where the player and the user are directly connected (one edge), they are deemed to be separated by one degree of separation. The user would be a so-called “first-degree friend” of the player. Where the player and the user are connected through one other user (two edges), they are deemed to be separated by two degrees of separation. This user would be a so-called “second-degree friend” of the player. Where the player and the user are connected through N edges (or N−1 other users), they are deemed to be separated by N degrees of separation. This user would be a so-called “Nth-degree friend.”

Within the social graph, each player (or player character) has a social network. A player's social network includes all users in the social graph within Nₘₐₓ degrees of the player, where Nₘₐₓ is the maximum degree of separation allowed by the system managing the social graph (such as, for example, social networking system 140 or game networking system 150). In one embodiment, Nₘₐₓ equals 1, such that the player's social network includes only first-degree friends. In another embodiment, Nₘₐₓ is unlimited and the player's social network is coextensive with the social graph.

In particular embodiments, the social graph is managed by game networking system 150, which is managed by the game operator. In other embodiments, the social graph is part of a social networking system 140 managed by a third-party (e.g., Facebook, Friendster, Myspace). In yet other embodiments, player 101 has a social network on both game networking system 150 and social networking system 140, wherein player 101 can have a social network on the game networking system 150 that is a subset, superset, or independent of the player's social network on social networking system 140. In such combined systems, game networking system 150 can maintain social graph information with edge type attributes that indicate whether a given friend is an “in-game friend,” an “out-of-game friend,” or both. The various embodiments disclosed herein are operable when the social graph is managed by social networking system 140, game networking system 150, or both.

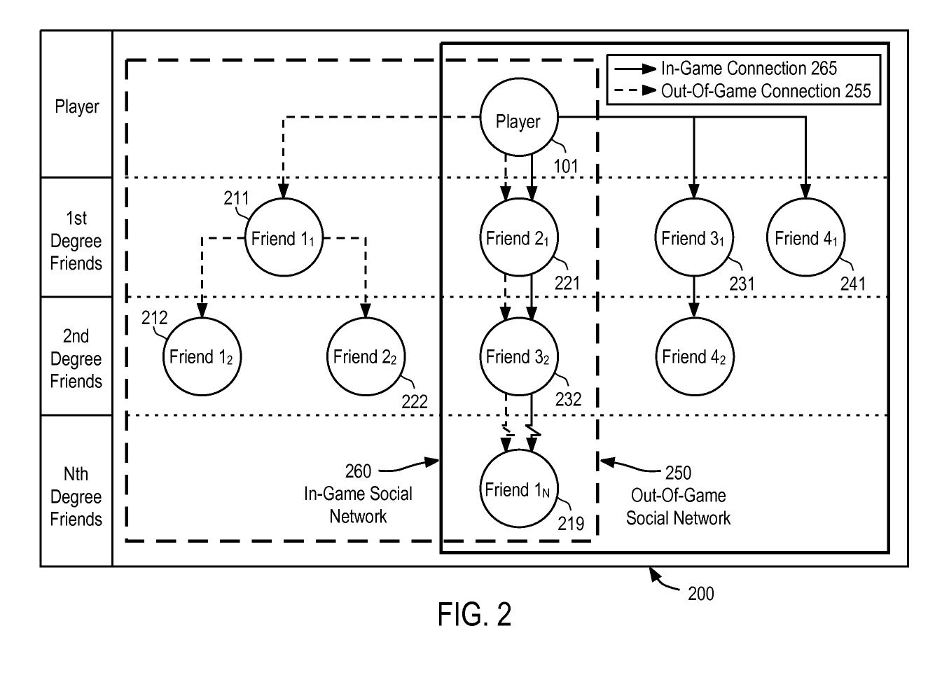

FIG. 2 shows an example of a social network within a social graph 200. As shown, player 101 can be associated, connected or linked to various other users, or “friends,” within the out-of-game social network 250. These associations, connections or links can track relationships between users within the out-of-game social network 250 and are commonly referred to as online “friends” or “friendships” between users. Each friend or friendship in a particular user's social network within a social graph is commonly referred to as a “node.” For purposes of illustration and not by way of limitation, the details of out-of-game social network 250 will be described in relation to player 101. As used herein, the terms “player” and “user” can be used interchangeably and can refer to any user in an online multiuser game system or social networking system. As used herein, the term “friend” can mean any node within a player's social network.

As shown in FIG. 2, player 101 has direct connections with several friends.

When player 101 has a direct connection with another individual, that connection is referred to as a first-degree friend. In out-of-game social network 250, player 101 has two first-degree friends. That is, player 101 is directly connected to friend 1₁ 211 and friend 2₁ 221. In a social graph, it is possible for individuals to be connected to other individuals through their first-degree friends (i.e., friends of friends). As described above, each edge required to connect a player to another user is considered the degree of separation. For example, FIG. 2 shows that player 101 has four second-degree friends to which he is connected via his connection to his first-degree friends. Second-degree friend 1₂ 212 and friend 2₂ 222 are connected to player 101 via his first-degree friend 1₁ 211. The limit on the depth of friend connections, or the number of degrees of separation for associations that player 101 is allowed is typically dictated by the restrictions and policies implemented by social networking system 140 (FIG. 1).

In various embodiments, player 101 can have Nth-degree friends connected to him through a chain of intermediary degree friends, as indicated in FIG. 2. For example, Nth-degree friend 1_{N} 219 is connected to player 101 via second-degree friend 3₂ 232 and one or more other higher-degree friends. Various embodiments may take advantage of and utilize the distinction between the various degrees of friendship relative to player 101.

In particular embodiments, a player (or player character) can have a social graph within an online multiplayer game that is maintained by the game engine and another social graph maintained by a separate social networking system. FIG. 2 depicts an example of in-game social network 260 and out-of-game social network 250. In this example, player 101 has out-of-game connections 255 to a plurality of friends, forming out-of-game social network 250. Here, friend 1₁ 211 and friend 2₁ 221 are first-degree friends with player 101 in his out-of-game social network 250. Player 101 also has in-game connections 265 to a plurality of players, forming in-game social network 260. Here, friend 2₁ 221, friend 3₁ 231, and friend 4₁ 241 are first-degree friends with player 101 in his in-game social network 260. In some embodiments, it is possible for a friend to be in both the out-of-game social network 250 and the in-game social network 260. Here, friend 2₁ 221 has both an out-of-game connection 255 and an in-game connection 265 with player 101, such that friend 2₁ 221 is in both player 101's in-game social network 260 and player 101's out-of-game social network 250. As used herein, players forming part of the in-game social network 260 may also be referred to as “friend players.”

As with other social networks, player 101 can have second-degree and higher-degree friends in both his in-game and out-of-game social networks. In some embodiments, it is possible for player 101 to have a friend connected to him both in his in-game and out-of-game social networks, wherein the friend is at different degrees of separation in each network. For example, if friend 2₂ 222 had a direct in-game connection with player 101, friend 2₂ 222 would be a second-degree friend in player 101's out-of-game social network 250, but a first-degree friend in player 101's in-game social network 260. In particular embodiments, a game engine can access in-game social network 260, out-of-game social network 250, or both.

In particular embodiments, the connections in a player's in-game social network 260 can be formed both explicitly (e.g., users must “friend” each other) and implicitly (e.g., system observes user behavior and “friends” users to each other). Unless otherwise indicated, reference to a friend connection between two or more players can be interpreted to cover both explicit and implicit connections, using one or more social graphs and other factors to infer friend connections. The friend connections can be unidirectional or bidirectional. It is also not a limitation of this description that two players who are deemed “friends” for the purposes of this disclosure are not friends in real life (i.e., in disintermediated interactions or the like), but that could be the case.

In multiplayer online games, two or more players can play in the same game instance. Game play is asynchronous when the players do not play simultaneously in the game instance. In particular embodiments, synchronous game play between two players in the same game instance can be simulated from asynchronous game play by recording the game play of a first player in the game instance at a first time and replaying that game play during the game play of a second player in the game instance at a later time. In particular embodiments, the game engine can record the in-game actions of a first player in a game instance for later play-back by other players in the game instance, and then the game engine loads and executes the previously recorded in-game actions during the game play of other players in the game instance.

### Example System

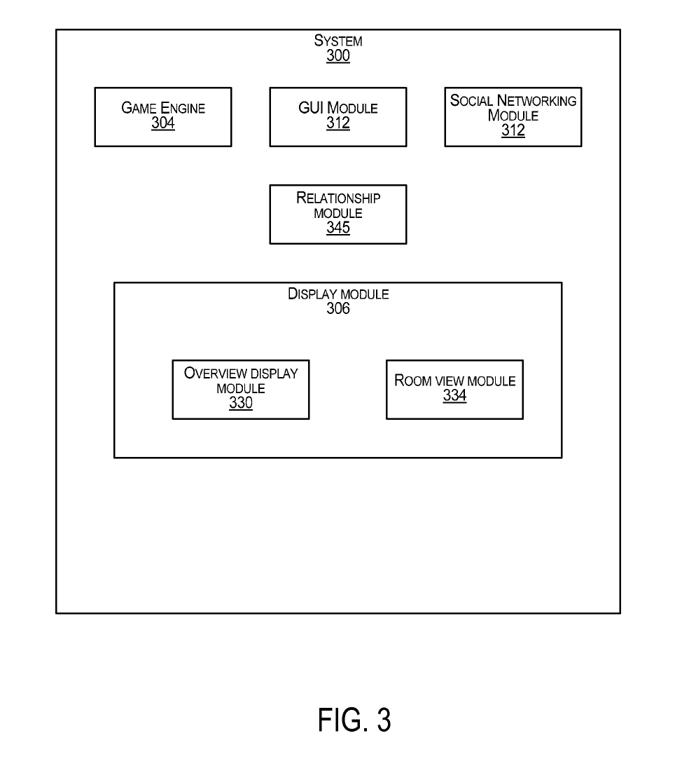

FIG. 3 illustrates an example system 300 for implementing particular disclosed embodiments. The system 300 may comprise a number of hardware-implemented modules provided by one or more processors. The system 300 may include a game engine 304 to manage a multiplayer online game. To this end, the game engine 304 may include game logic to manage in-game objects and nonplayer character behavior, and to execute in-game actions responsive to user input. Although other illustrated modules of the system 300 are shown in FIG. 3 to be separate from the game engine 304, one or more of these modules may form part of a module that provides the game engine 304. Two or more of the modules of FIG. 3 may likewise form part of the same module, and the functional separation of different models in FIG. 3 is not restrictive as to their arrangement and/or functional interrelationships.

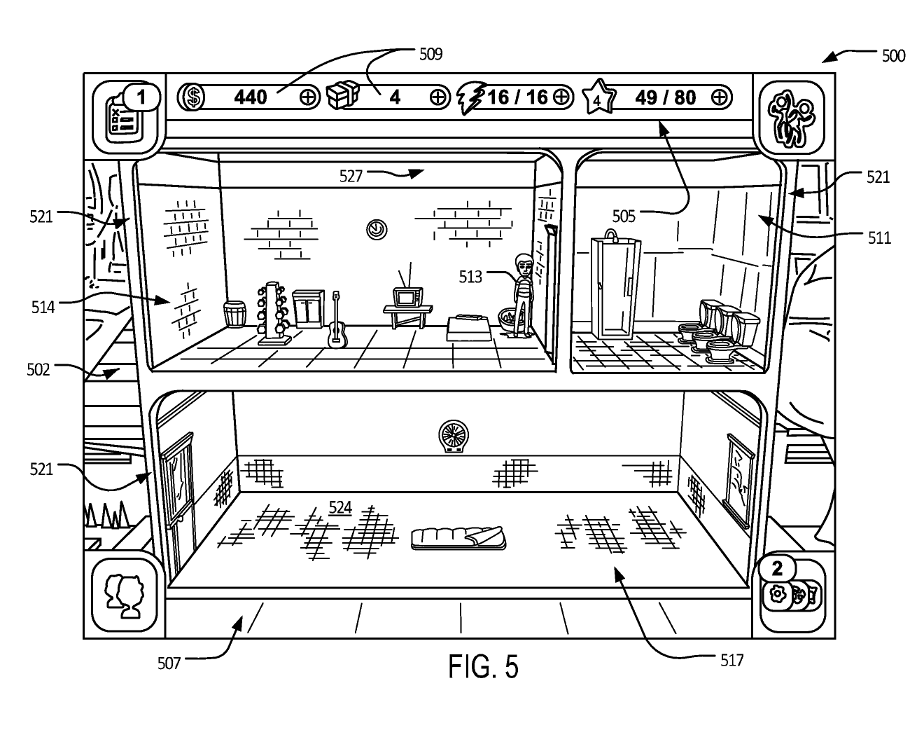

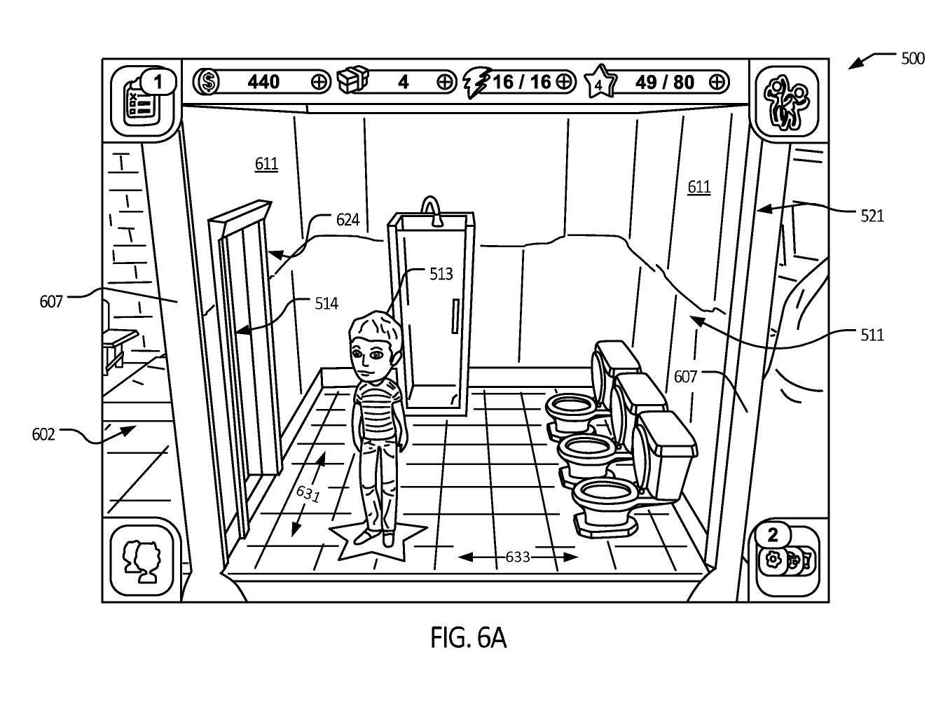

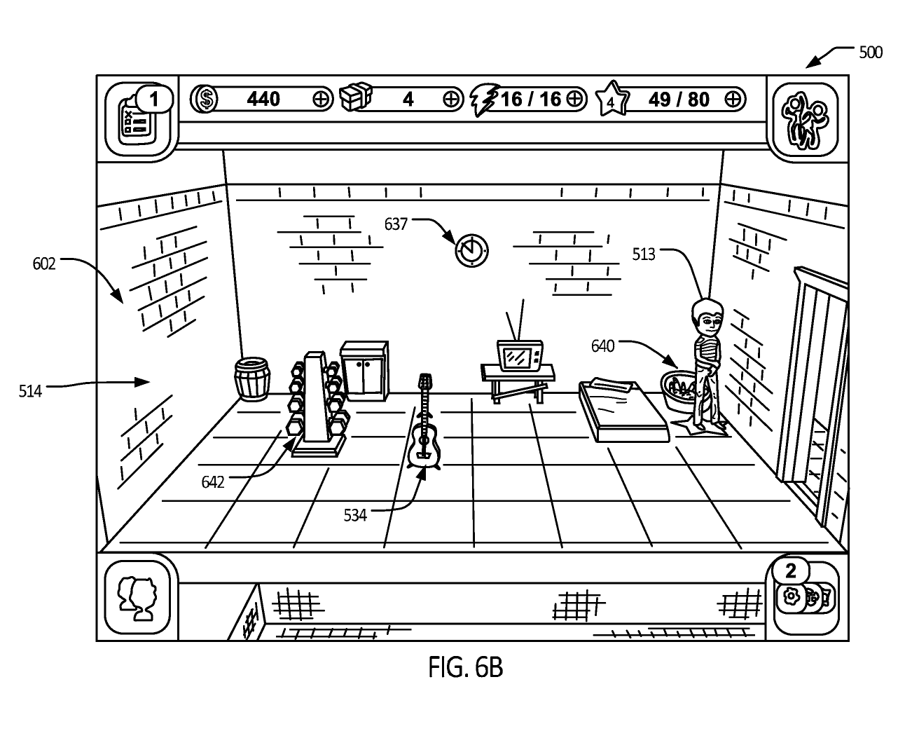

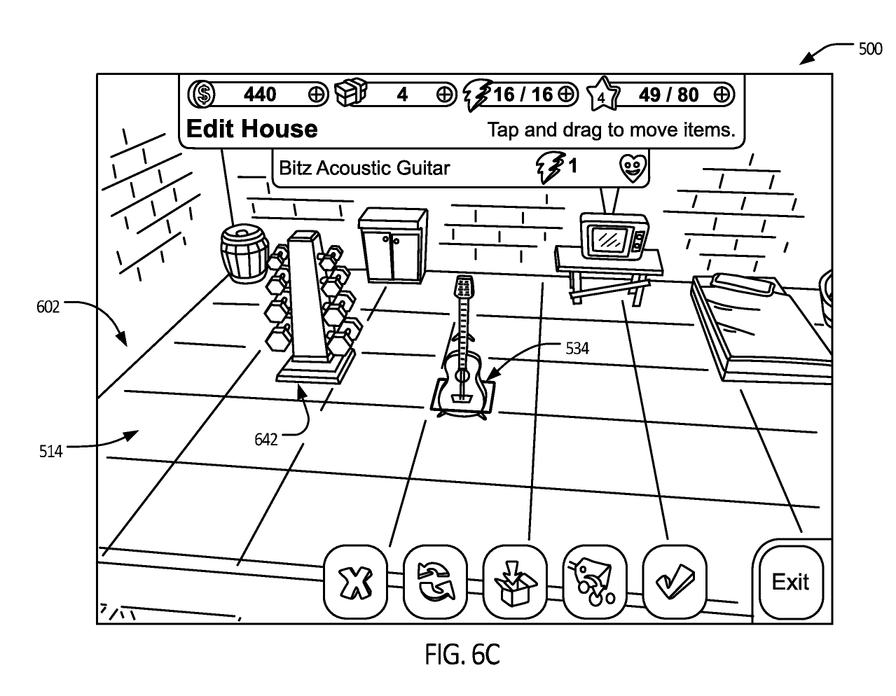

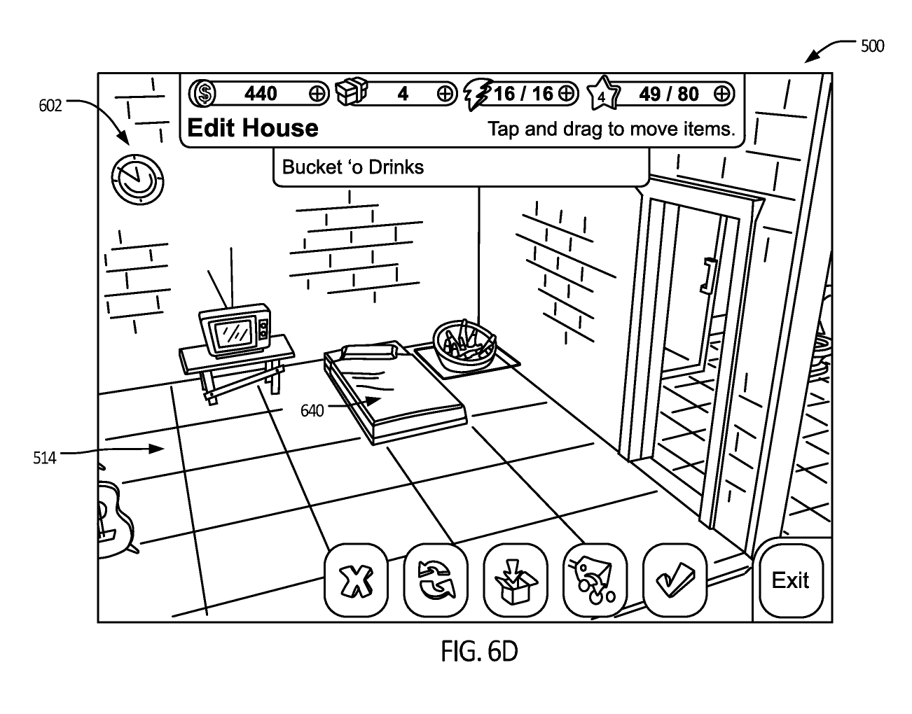

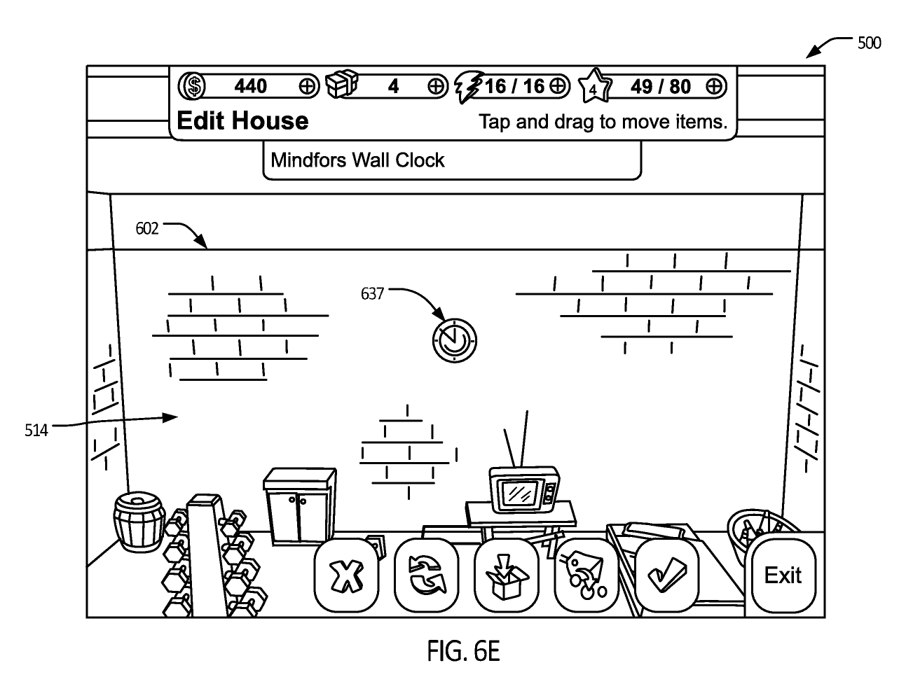

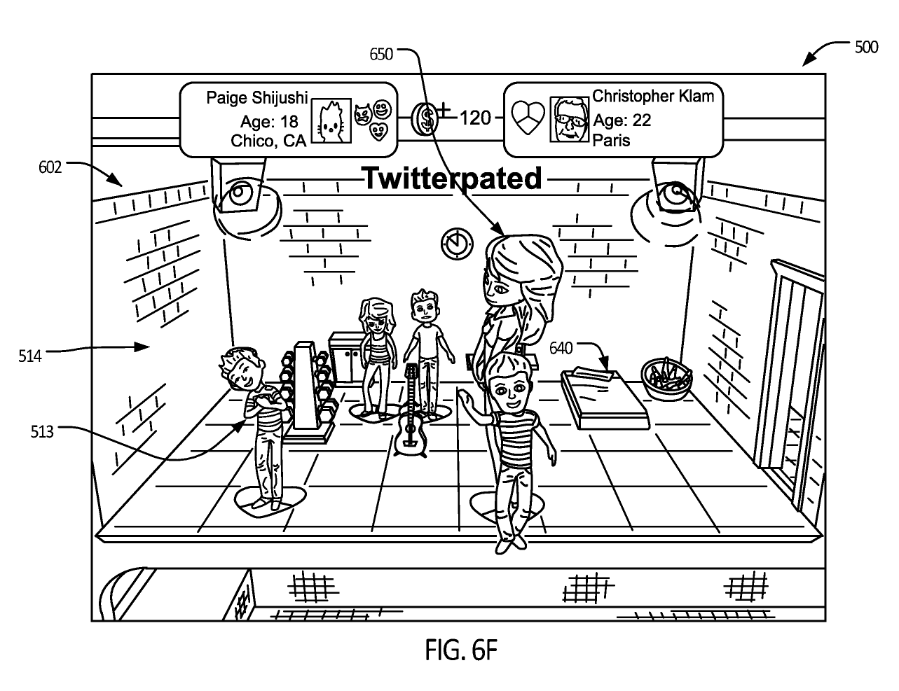

The system 300 may further include a display module 306 to provide a game display on a client device, the game display being associated with a player of the computer-implemented multiplayer game. The game display may be of a particular game instance associated with a particular player 101. The game display typically comprises an environment view that shows a virtual in-game environment of the particular game instance (in the example embodiments described herein constituting a virtual house), and a graphical user interface to receive user input and to display game related information to the user. Examples of such game displays will be described later herein with reference to FIGS. 5 and 6. To this end, the system 300 may include a graphical user interface (GUI) module 312 to generate a graphical user interface in the game display.

The GUI module 306 may, in this example, comprise an overview display module 330 to generate an interactive overview of a virtual building defining the in-game world (see for example FIG. 5. The GUI module 306 may further comprise a room view module 334 to generate and manage a dynamic, interactive close-up view of a selected room in isolation, in which a point of view of the user is defined by a mostly fixed camera position, from which a direction can automatically be swiveled to direct camera focus to relevant game action and move into the virtual depth to frame the action to a specific percent of the screen dimensions. An example of such close-up, isolated room views are described later herein with reference to FIGS. 6A-6F

A social networking module 305 may be provided to create and maintain the in-game social network 260 and/or the out-of-game social network 250.

In some embodiments, the system 300 may include a relationship module 345 to manage relationships between respective players 101 of the game. The relationship module 345 may be configured to provide individualized relationship statuses or individualized relationship scores between players, so that, for example, each relationship score or status is with respect to a bilateral relationship between a respective two players.

Functionality of the system 300 and its respective modules, in accordance with the example embodiment, is further described below with respect to example methods.

### Example Methods

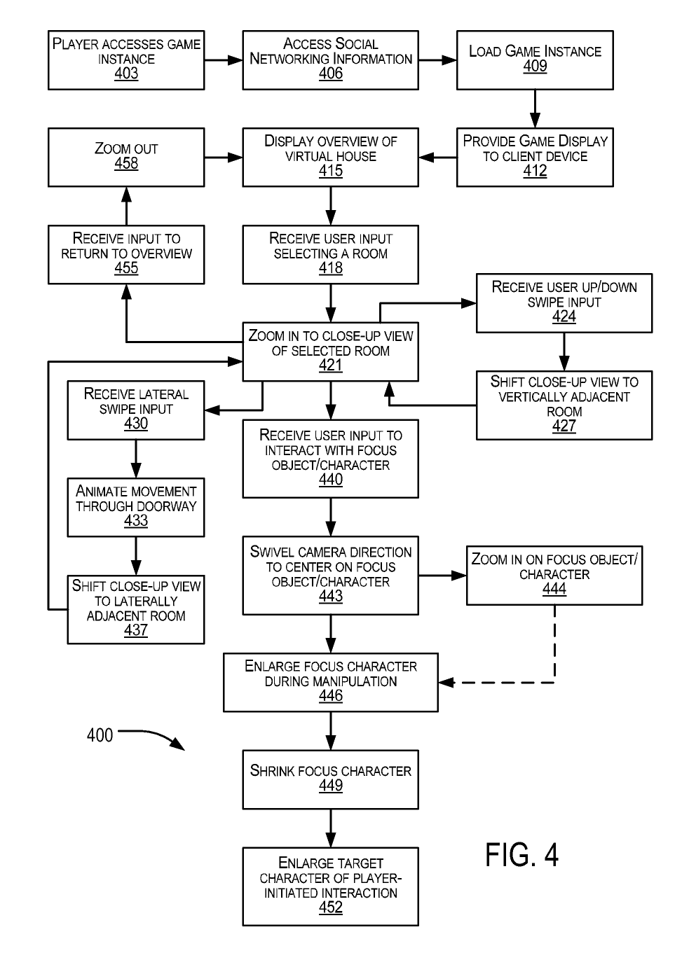

FIG. 4 shows a high-level flow chart of an example embodiment of a method 400 to host or provide a computer-implemented multiplayer game. The method 400 may be implemented in one embodiment by example system 300, described above with reference to FIG. 3, in the example game environment described in FIGS. 1 and 2. Example game displays that may be generated in the performance of method 400 are described with reference to FIGS. 5 and 6.

A player 101 (FIG. 1) of a computer-implemented multiplayer game may access a game instance that is associated with him/her, and may also visit the game instances of friend players 221. In the description that follows, a player that is uniquely associated with a particular game instance in which the described actions are performed (e.g., being the host player) is referred to as player 101. Players of the game who are friends of the player 101 in the in-game social network 260 and/or in the out-of-game social network 250, and as a result have access rights to the game instance of the player 101 are “friend players” of the player 101.

The present example is with respect to a residential environment in which each player's game instance comprises a building in the example form of a house 507 (see FIG. 5).

At operation 403, the player 101 (FIG. 1) may access a game instance that is associated with him/her. The player 101 may, for example, access a multiplayer online game on game networking system 150, social networking system 140, or both (FIG. 1). In this example embodiment, and not by way of limitation, the player 101 may access, via client system 130 (FIG. 1), a webpage hosted by social networking system 140, wherein the webpage has an embedded game interface hosted by the game networking system 150. In such a case, the system 300 providing the game engine 304 (FIG. 3) may be provided by the game networking system 150. In other embodiments, the game engine 304 may be provided by or installed on the client system 130.

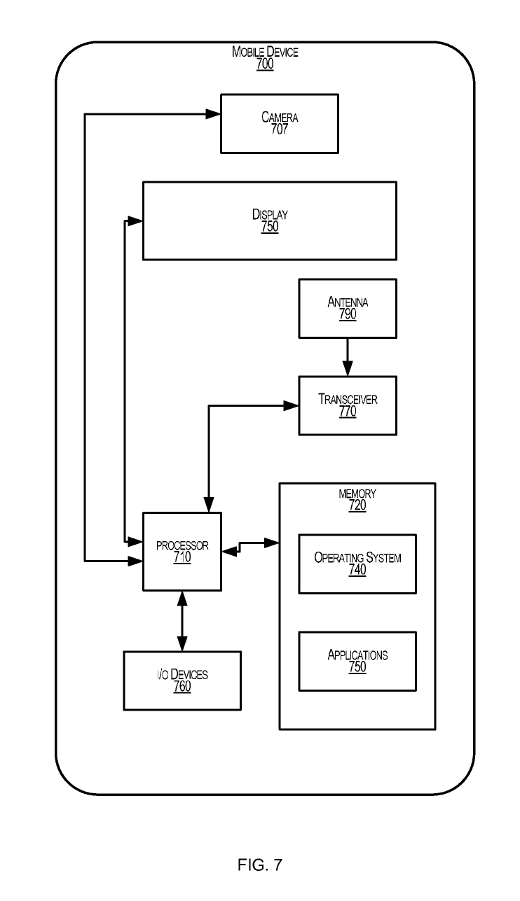

The current example embodiment is also described as being implemented on a mobile electronic device, in the example form of a mobile phone with a touchscreen interface. An example of such a mobile device is later described with reference to FIG. 7.

Social networking information associated with the player 101, as well as in-game event information and state information relevant to the particular game instance that is being accessed may thereafter be accessed, at operation 406. In particular embodiments, social networking information on the social networking system 140, the game networking system 150, or both may be accessed. In some embodiments, game instances can be selected from a set of game instances associated with the player 101's friends 221 (FIG. 2) in the relevant social network. Here, the player 101 selects the game instance uniquely associated with him/her.

The game engine 304 may thereafter load the relevant game instance, at 409, and may generate a game display for the selected game instance, at 412.

In this example, providing an initial or home view of an example game display 500 (FIG. 5) comprises displaying an overview 502 of the virtual house 507, at operation 415. The virtual house 507 comprises multiple compartments or rooms that together define the virtual, three-dimensional game world with which player characters can interact and that can be navigated by such player characters. FIG. 5 shows an example player character 513 that is under the control of the player 101 whose game instance is shown.

In addition to the house 507, the game display 500 comprises a graphical user interface 505 having multiple graphical user interface elements 509. Note, however, that because this example game display is provided on a computer device with a touch screen interface, user input may be received by sensing touch gestures and put directly on respective areas and/or objects in the game display 500. Substantially the entirety of the game display 500, including the house 507, therefore forms a holistic graphical user interface.

The overview 502 thus serves as a gameboard that provides a broad overview of the entire game world available to the player 101 in the game instance.

In this example, the house 507 comprises three rooms in the example form of a bathroom 511, a living room 517, and a media room 514.

The overview 502 may comprise an elevational, side on view of the house 507. A point of view from which the overview 502 is shown to the player 101 is thus at a height in the virtual world that is vertically centered in the overall height of the house 507, with a camera direction being close to perpendicular to a front wall 521 that is common to all of the rooms and is shown as transparent, effectively being omitted or peeled away in the overview 502. The overview 502 thus provides a dollhouse-type view of the house 507, with each room having an open side or mouth at its front wall 521 through which the interiors of the respective rooms are simultaneously exposed to view.

The overview 502 is, in this example, a linear perspective view having a vanishing point more or less level with the camera position. Because the camera position is furthermore located more or less centrally in a lateral dimension of the house 507, inner surfaces of outer walls at opposite lateral extremities of the house 507 are visible at the same time. A lowest floor of the house 507, in this case the floor 524 of the living room 517 is visible at the same time as an uppermost ceiling of the house 507, in this case provided by the ceiling 527 of the media room 514. The camera will frame the entire house 507 to take up to 90% of the screen width or height (depending on which occurs first). This ensures that the entire house is displayed on devices of varying aspect ratios.

During gameplay, the house 507 may be extended by player 101 by the addition of extra rooms. In this example, such additions are limited to rooms that are laterally and/or vertically aligned with existing rooms, so that the house 507 will always be a single room-level deep for all allowable combination of rooms. For example, expansion of the virtual building may be limited during gameplay to the addition of rooms that have an edge (e.g., floor, ceiling or side wall) that lies in a vertical plane common to a multiple rooms arrangement.

The overview 502, in this example, provides a three-dimensional interactive space, in that the player character 513 can be controlled to move within a particular room both laterally (e.g., to walk from one end of the media room to the other), and to move in a depth dimension towards or away from the camera position.

Returning now to FIG. 4, user input may be received, at operation 418, indicating selection of a particular one of the rooms of the house 507, responsive to which, the game display may zoom in on the selected room to show a close-up, isolated view of that room, at operation 421. FIG. 6A, for example, shows such a close-up view 602 of the bathroom 511.

As can be seen, the close-up view 602 is on an enlarged scale, relative to that of the overview, and shows only the selected room 511, substantially in isolation. The method may comprise either automatically scaling the view (in the case of a tap) or linearly zooming in with a pinch gesture such that the selected room 511 fills the available screen space up to a max screen-size percentage, regardless of the size of the selected room relative to the other rooms of the house 507. Compare, for example, the close-up view of the bathroom 511 (FIG. 6A), with a similar close-up view of the larger media room 514 (FIG. 6B), in which the same player character 513 has a smaller screen size.

Note also, however, that because the close-up view 602 is shown in linear perspective, the player character 513 will grow in size as it approaches the screen position at the invisible front wall 521, and will similarly become smaller as it moves away from the camera position.

As mentioned, the close-up view 602 is a linear perspective view similar to the overview 502, with a close-up view camera position being located centrally along the lateral width of the selected room 521.

In one embodiment, player character movement within and between rooms can also be effected, in the overview, for example by touch gestures on a touchscreen interface. In another embodiment, player character movement between rooms can only be effected in a close-up, isolated view of a particular room (described below). In this embodiment, the game and display zooms to a selected room responsive to user's selection, whereafter the player character (if in another room) is moved to the selected room, and is controllable to move about within the selected room in this close-up-isolated view. The player character 513 can be manipulated by the player 101 to move about in the virtual three-dimensional space of the selected room 521 both in a depth dimension 631 and in a lateral dimension 633. Again, due to the camera position in the perspective view, inner surfaces 611 of opposite side walls 607 of the bathroom 511 are simultaneously visible, so that no part of the room's interior space is obstructed by one of the side walls.

One of the side walls 607 is shown as having a doorway 624 through which at least part of a laterally adjacent room is visible.

In the close-up view 602, the side walls, ceiling, and floor, the room that is in focus is shown in cross-section, together forming a rectangle or square (depending on the room's dimensions) that frames the view.

The method 400 may include moving camera focus from one room to another, while in room view, responsive to user input. Thus, for example, user input may be received, at operation 424, consisting of an up or down swipe on a touch screen interface, responsive to which the close-up view may animate to a vertically adjacent room, at operation 427. Switching of views between respective rooms will include showing animated movement of the player character 513 to the newly selected room or animate through a doorway if one is available.

Similarly, user input directing lateral movement may be received, for example, by a lateral touchscreen swipe, responsive to which focus may animate to a laterally adjacent room, at operation 437. The method 400 will include displaying animated movement of the player character 613 through a doorway (e.g., 624) and into the new room.

The method 400 may further comprise receiving user input, at operation 440, to interact with or focus on a game object or game character in the selected room, responsive to which camera focus may automatically be directed to the focus object or focus character. In this example, such change in camera focus may comprise swiveling the camera direction, at operation 443, while the camera position remains mostly fixed. The camera may slightly move towards or away from the focus object to ensure that it's framed by 30% of the screen space

Consider, for example, the media room 514 shown in a close-up view in FIG. 6B. The media room 514 comprises a number of game objects, in the example form of a guitar 634, a weight stand 642, a wall clock 637, and a beer tub 640. While initial camera direction is towards the vanishing point, less looking in a direction parallel to the room's side walls and perpendicular to its back wall.

When the user selects, for example, the guitar 634 (FIG. 6C), the imaginary camera that defines the point of view of the player 101 swivels leftwards and downwards, so that the selected guitar 634, which is now the focus object, is positioned centrally in the screen. The method may further include zooming in on the focus object, at operation 444, so that it is shown enlarged and therefore in greater detail. Note that, although shifting of camera focus by swiveling the camera direction and zooming in is described with reference to game objects, the same actions may be performed when the focus of game action is a player character or any other appropriate game element.

FIG. 6D shows the same close-up view of the media room 514, but in which the beer tub in the right rear corner of the media room 514 is selected as focus object, with the camera now having swiveled to its right relative to the view shown in FIG. 6C. Note that such swiveling of the camera direction changes the on-screen angle of the game objects and the in-game environment.

This enables intuitive orientation of the user relative to the virtual three-dimensional space, even when the view is zoomed in to a level greater than that shown in FIG. 6D.

Similarly, selection of the wall clock 637, shown in FIG. 6E, results in the camera swiveling upwards relative to its prior views, and zooming in on the wall clock 637.

The method 400 may yet further include, responsive to user manipulation of a player character or object, automatically enlarging the on screen size of the manipulated character/object, at operation 446 (FIG. 4). In FIG. 6F, for example, a friend player character 650 is shown as being moved towards the friend player character 513, and this focus character is shown as being bigger during such a relation than is otherwise the case.

When the manipulated player character 650 is placed at a desired location for interaction with another player character or object, in this example being intended to interact with their character 513, the method may comprise automatically shrinking (, e.g., using a scaling filter) the focus character, at 449, to its normal size. In some embodiments, the method may include automatically enlarging a target character at which the character manipulation is directed. Thus, in the example of FIG. 6F, placement of the friend player characters 650 next to the player character 513 in order to perform an interaction between the characters may result in automatic enlargement of the player character 513, being the target player of the interaction.

Some automatic enlargement and/or shrinking may be provided with respective focus and/or target objects.

The method 400 may include, at any stage, receiving user input to return to the overview 502, at operation 455, for example by pinching out on the touchscreen display. In response, the game display 500 may smoothly zoom out from the close-up view of the selected room, at operation 458, to return to the overview 502. This can be done as a gesture that will automatically animate to the final position, or as a one-to-one swipe where the user can control the distance based on their active touch.

It is a benefit of the method and system of game display and player navigation through a virtual three-dimensional space in a game world defined by a built environment that it increases effective use of necessarily limited screen space, for example, by zooming in on rooms, objects, and characters that are the focus of gameplay.

While such dynamic zooming in on the action provides views in greater detail, it can result in their disorientation in the three-dimensional game world. Features associated with smooth the zooming in from a three-dimensional overview to a similar three-dimensional close-up view, and having a fixed camera position for each room view, regardless of the area of focus, assist players in locating themselves intuitively in the three dimensional space. A fixed, swiveling camera position, for example, more closely approximates human view finding in the real world.

The described linear perspective views have the further benefit of providing a clear, unobstructed view of substantially the entirety of the respective rooms' interior.

The described methods and systems thus provide disclose a computer-implemented method that comprises displaying an overview of a virtual world for a game instance of a multiplayer online game, the virtual world being defined by a virtual building having multiple rooms, the overview comprising an elevational view in which respective interiors of the multiple rooms are simultaneously visible; receiving user input indicating selection of a particular one of the multiple rooms; and responsive to the input, displaying on an enlarged scale relative to the overview a close-up view of the interior of the selected room, the close-up view showing a virtual three-dimensional space that is accessible to one or more player characters by animated movement in a lateral dimension and in a depth dimension relative to a close-up camera position from which the close-up view is shown.

### Example Mobile Device

FIG. 7 is a block diagram illustrating an example embodiment of a mobile device 700 that may be employed to provide the functionalities described, e.g., with reference to FIG. 3. The mobile device 700 may include a processor 710. The processor 710 may be any of a variety of different types of commercially available processors suitable for mobile devices (for example, an XScale architecture microprocessor, a Microprocessor without Interlocked Pipeline Stages (MIPS) architecture processor, or another type of processor). A memory 720, such as a Random Access Memory (RAM), a Flash memory, or other type of memory, is typically accessible to the processor. The memory 720 may be adapted to store an operating system (OS) 740, as well as application programs 750 (among which may be included applications to provide one or more of the modules described with reference to FIG. 3). The processor 710 may be coupled, either directly or via appropriate intermediary hardware, to a display 750 and to one or more input/output (I/O) devices 760, such as a keypad, a touch panel sensor, a microphone, and the like. The display 750 may provide a touch screen I/O device. In some embodiments, the processor 710 may be coupled to a transceiver 770 that interfaces with an antenna 790. The transceiver 770 may be configured to both transmit and receive cellular network signals, wireless data signals, or other types of signals via the antenna 790, depending on the nature of the mobile device 700. Further, in some configurations, a GPS receiver 780 may also make use of the antenna 790 to receive GPS signals.

### Data Flow

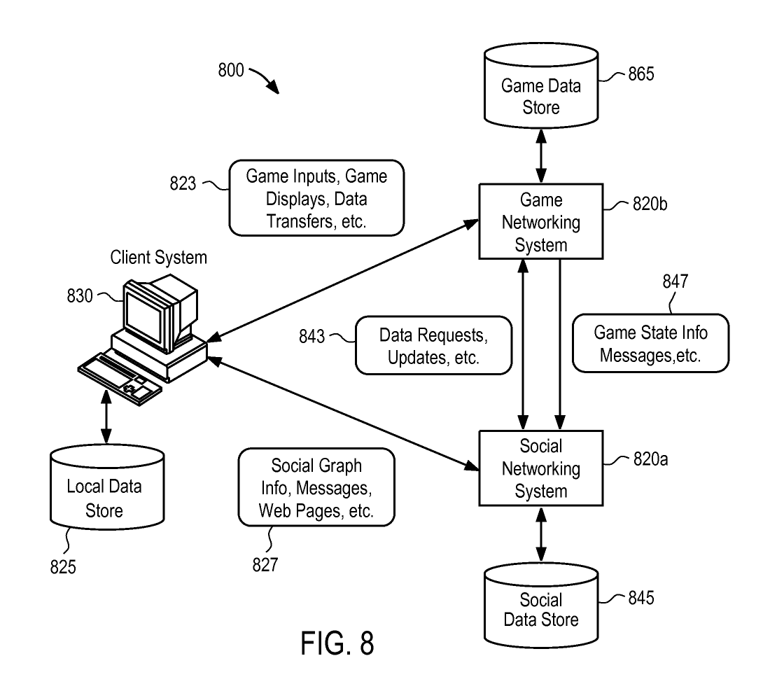

FIG. 8 illustrates an example data flow between the components of an example system 800. In particular embodiments, system 800 can include client system 830, social networking system 820a, and game networking system 820b. A system 300 such as that described with reference to FIG. 3 may be provided by the client system 830, the social networking system 820a, or the game networking system 820b, or by any combination of these systems. The components of system 800 can be connected to each other in any suitable configuration, using any suitable type of connection. The components may be connected directly or over any suitable network. Client system 830, social networking system 820a, and game networking system 820b can each have one or more corresponding data stores such as local data store 825, social data store 845, and game data store 865, respectively. Social networking system 820a and game networking system 820b can also have one or more servers that can communicate with client system 830 over an appropriate network. Social networking system 820a and game networking system 820b can have, for example, one or more Internet servers for communicating with client system 830 via the Internet. Similarly, social networking system 820a and game networking system 820b can have one or more mobile servers for communicating with client system 830 via a mobile network (e.g., GSM, PCS, Wi-Fi, WPAN, etc.). In some embodiments, one server may be able to communicate with client system 830 over both the Internet and a mobile network. In other embodiments, separate servers can be used.

Client system 830 can receive and transmit data 823 to and from game networking system 820b. This data can include, for example, webpages, messages, game inputs, game displays, HTTP packets, data requests, transaction information, updates, and other suitable data. At some other time, or at the same time, game networking system 820b can communicate data 843, 847 (e.g., game state information, game system account information, page info, messages, data requests, updates, etc.) with other networking systems, such as social networking system 820a (e.g., Facebook, Myspace, etc.). Client system 830 can also receive and transmit data 827 to and from social networking system 820a. This data can include, for example, webpages, messages, social graph information, social network displays, HTTP packets, data requests, transaction information, updates, and other suitable data.

Communication between client system 830, social networking system 820a, and game networking system 820b can occur over any appropriate electronic communication medium or network using any suitable communications protocols. For example, client system 830, as well as various servers of the systems described herein, may include Transport Control Protocol/Internet Protocol (TCP/IP) networking stacks to provide for datagram and transport functions. Of course, any other suitable network and transport layer protocols can be utilized.

In addition, hosts or end-systems described herein may use a variety of higher layer communications protocols, including client-server (or request-response) protocols, such as HTTP, other communications protocols, such as HTTP-S, FTP, SNMP, TELNET, and a number of other protocols may be used. In addition, a server in one interaction context may be a client in another interaction context. In particular embodiments, the information transmitted between hosts may be formatted as HyperText Markup Language (HTML) documents. Other structured document languages or formats can be used, such as XML and the like. Executable code objects, such as JavaScript and ActionScript, can also be embedded in the structured documents.

In some client-server protocols, such as the use of HTML over HTTP, a server generally transmits a response to a request from a client. The response may comprise one or more data objects. For example, the response may comprise a first data object, followed by subsequently transmitted data objects. In particular embodiments, a client request may cause a server to respond with a first data object, such as an HTML page, which itself refers to other data objects. A client application, such as a browser, will request these additional data objects as it parses or otherwise processes the first data object.

In particular embodiments, an instance of an online game can be stored as a set of game state parameters that characterize the state of various in-game objects, such as, for example, player character state parameters, non-player character parameters, and virtual item parameters. In particular embodiments, game state is maintained in a database as a serialized, unstructured string of text data as a so-called binary large object (BLOB). When a player accesses an online game on game networking system 820b, the BLOB containing the game state for the instance corresponding to the player can be transmitted to client system 830 for use by a client-side executed object to process. In particular embodiments, the client-side executable may be a Flash-based game, which can de-serialize the game state data in the BLOB. As a player plays the game, the game logic implemented at client system 830 maintains and modifies the various game state parameters locally. The client-side game logic may also batch game events, such as mouse clicks, and transmit these events to game networking system 820b. Game networking system 820b may itself operate by retrieving a copy of the BLOB from a database or an intermediate memory cache (memcache) layer. Game networking system 820b can also de-serialize the BLOB to resolve the game state parameters and execute its own game logic based on the events in the batch file of events transmitted by the client to synchronize the game state on the server side. Game networking system 820b may then re-serialize the game state, now modified, into a BLOB, and pass this to a memory cache layer for lazy updates to a persistent database.

With a client-server environment in which the online games may run, one server system, such as game networking system 820b, may support multiple client systems 830. At any given time, there may be multiple players at multiple client systems 830 all playing the same online game. In practice, the number of players playing the same game at the same time may be very large. As the game progresses with each player, multiple players may provide different inputs to the online game at their respective client systems 830, and multiple client systems 830 may transmit multiple player inputs and/or game events to game networking system 820b for further processing. In addition, multiple client systems 830 may transmit other types of application data to game networking system 820b.

In particular embodiments, a computed-implemented game may be a text-based or turn-based game implemented as a series of web pages that are generated after a player selects one or more actions to perform. The web pages may be displayed in a browser client executed on client system 830. As an example and not by way of limitation, a client application downloaded to client system 830 may operate to serve a set of webpages to a player. As another example and not by way of limitation, a computer-implemented game may be an animated or rendered game executable as a stand-alone application or within the context of a webpage or other structured document. In particular embodiments, the computer-implemented game may be implemented using Adobe Flash-based technologies. As an example and not by way of limitation, a game may be fully or partially implemented as a Small Web Format (SWF) object that is embedded in a web page and executable by a Flash media player plug-in. In particular embodiments, one or more described webpages may be associated with or accessed by social networking system 820a. This disclosure contemplates using any suitable application for the retrieval and rendering of structured documents hosted by any suitable network-addressable resource or website.

Application event data of a game is any data relevant to the game (e.g., player inputs). In particular embodiments, each application datum may have a name and a value, and the value of the application datum may change (i.e., be updated) at any time. When an update to an application datum occurs at client system 830, either caused by an action of a game player or by the game logic itself, client system 830 may need to inform game networking system 820b of the update. For example, if the game is a farming game with a harvest mechanic (such as Zynga FarmVille), an event can correspond to a player clicking on a parcel of land to harvest a crop. In such an instance, the application event data may identify an event or action (e.g., harvest) and an object in the game to which the event or action applies. For illustration purposes and not by way of limitation, system 800 is discussed in reference to updating a multi-player online game hosted on a network-addressable system (such as, for example, social networking system 820a or game networking system 820b), where an instance of the online game is executed remotely on a client system 830, which then transmits application event data to the hosting system such that the remote game server synchronizes the game state associated with the instance executed by the client system 830.

In a particular embodiment, one or more objects of a game may be represented as an Adobe Flash object. Flash may manipulate vector and raster graphics, and supports bidirectional streaming of audio and video. “Flash” may mean the authoring environment, the player, or the application files. In particular embodiments, client system 830 may include a Flash client. The Flash client may be configured to receive and run Flash application or game object code from any suitable networking system (such as, for example, social networking system 820a or game networking system 820b). In particular embodiments, the Flash client may be run in a browser client executed on client system 830. A player can interact with Flash objects using client system 830 and the Flash client. The Flash objects can represent a variety of in-game objects. Thus, the player may perform various in-game actions on various in-game objects by making various changes and updates to the associated Flash objects. In particular embodiments, in-game actions can be initiated by clicking or similarly interacting with a Flash object that represents a particular in-game object. For example, a player can interact with a Flash object to use, move, rotate, delete, attack, shoot, or harvest an in-game object. This disclosure contemplates performing any suitable in-game action by interacting with any suitable Flash object. In particular embodiments, when the player makes a change to a Flash object representing an in-game object, the client-executed game logic may update one or more game state parameters associated with the in-game object. To ensure synchronization between the Flash object shown to the player at client system 830 and the game networking system 820b, the Flash client may send the events that caused the game state changes to the in-game object to game networking system 820b. However, to expedite the processing and hence the speed of the overall gaming experience, the Flash client may collect a batch of some number of events or updates into a batch file. The number of events or updates may be determined by the Flash client dynamically or determined by game networking system 820b based on server loads or other factors. For example, client system 830 may send a batch file to game networking system 820b whenever 50 updates have been collected or after a threshold period of time, such as every minute.

As used herein, the term “application event data” may refer to any data relevant to a computer-implemented game application that may affect one or more game state parameters, including, for example and without limitation, changes to player data or metadata, changes to player social connections or contacts, player inputs to the game, and events generated by the game logic. In particular embodiments, each application datum may have a name and a value. The value of an application datum may change at any time in response to the game play of a player or in response to the game engine (e.g., based on the game logic). In particular embodiments, an application data update occurs when the value of a specific application datum is changed. In particular embodiments, each application event datum may include an action or event name and a value (such as an object identifier). Thus, each application datum may be represented as a name-value pair in the batch file. The batch file may include a collection of name-value pairs representing the application data that have been updated at client system 830. In particular embodiments, the batch file may be a text file and the name-value pairs may be in string format.

In particular embodiments, when a player plays an online game on client system 830, game networking system 820b may serialize all the game-related data, including, for example and without limitation, game states, game events, and user inputs, for this particular user and this particular game into a BLOB and store the BLOB in a database. The BLOB may be associated with an identifier that indicates that the BLOB contains the serialized game-related data for a particular player and a particular online game. In particular embodiments, while a player is not playing the online game, the corresponding BLOB may be stored in the database. This enables a player to stop playing the game at any time without losing the current state of the game that the player is in. When a player resumes playing the game next time, game networking system 820b may retrieve the corresponding BLOB from the database to determine the most-recent values of the game-related data. In particular embodiments, while a player is playing the online game, game networking system 820b may also load the corresponding BLOB into a memory cache so that the game system may have faster access to the BLOB and the game-related data contained therein.

### Systems and Methods

In particular embodiments, one or more described webpages may be associated with a networking system or networking service. However, alternate embodiments may have application to the retrieval and rendering of structured documents hosted by any type of network addressable resource or web site. Additionally, as used herein, a user may be an individual, a group, or an entity (such as a business or third party application).

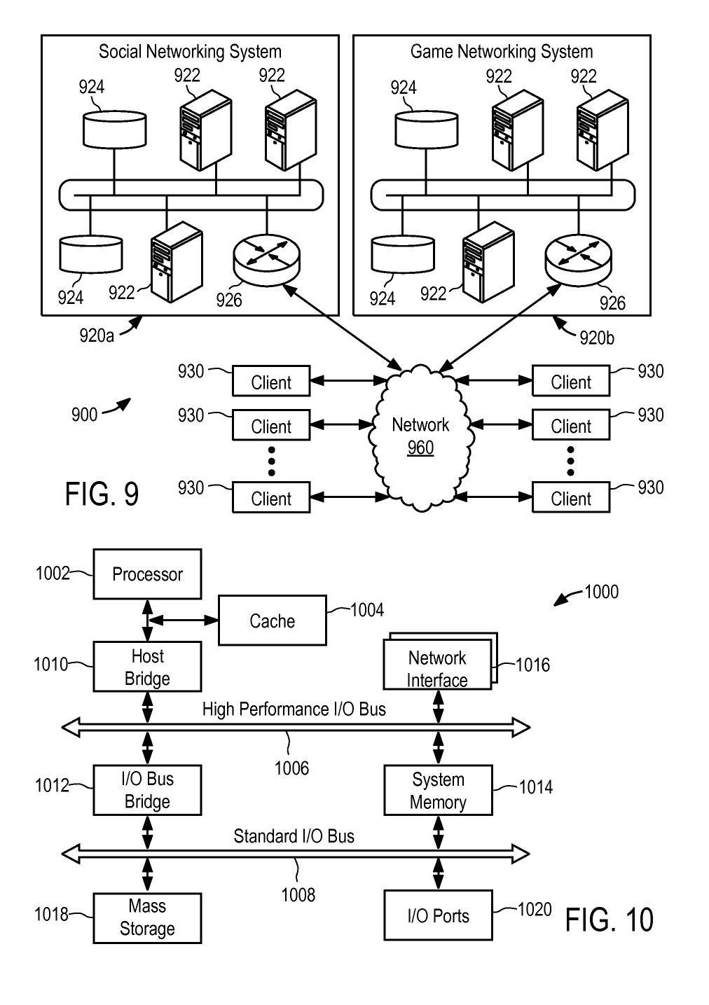

Particular embodiments may operate in a WAN environment, such as the Internet, including multiple network addressable systems. FIG. 9 illustrates an example network environment 900, in which various example embodiments may operate. Network cloud 960 generally represents one or more interconnected networks, over which the systems and hosts described herein can communicate. Network cloud 960 may include packet-based WAN (such as the Internet), private networks, wireless networks, satellite networks, cellular networks, paging networks, and the like. As FIG. 9 illustrates, particular embodiments may operate in a network environment comprising one or more networking systems, such as social networking system 920a, game networking system 920b, and one or more client systems 930. The components of social networking system 920a and game networking system 920b operate analogously; as such, hereinafter they may be referred to simply at networking system 920. Client systems 930 are operably connected to the network environment via a network service provider, a wireless carrier, or any other suitable means.

Networking system 920 is a network addressable system that, in various example embodiments, comprises one or more physical servers 922 and data stores 924. The one or more physical servers 922 are operably connected to network cloud 960 via, by way of example, a set of routers and/or networking switches 926. In an example embodiment, the functionality hosted by the one or more physical servers 922 may include web or HTTP servers, FTP servers, and, without limitation, webpages and applications implemented using Common Gateway Interface (CGI) script, PHP Hyper-text Preprocessor (PHP), Active Server Pages (ASP), HTML, XML, Java, JavaScript, Asynchronous JavaScript and XML (AJAX), Flash, ActionScript, and the like.

Physical servers 922 may host functionality directed to the operations of networking system 920. Hereinafter servers 922 may be referred to as server 922, although server 922 may include numerous servers hosting, for example, networking system 920, as well as other content distribution servers, data stores, and databases. Data store 924 may store content and data relating to, and enabling, operation of networking system 920 as digital data objects. A data object, in particular embodiments, is an item of digital information typically stored or embodied in a data file, database, or record. Content objects may take many forms, including: text (e.g., ASCII, SGML, HTML), images (e.g., jpeg, tif and gif), graphics (vector-based or bitmap), audio, video (e.g., mpeg), or other multimedia, and combinations thereof. Content object data may also include executable code objects (e.g., games executable within a browser window or frame), podcasts, and the like. Logically, data store 924 corresponds to one or more of a variety of separate and integrated databases, such as relational databases and object-oriented databases that maintain information as an integrated collection of logically related records or files stored on one or more physical systems. Structurally, data store 924 may generally include one or more of a large class of data storage and management systems. In particular embodiments, data store 924 may be implemented by any suitable physical system(s) including components, such as one or more database servers, mass storage media, media library systems, storage area networks, data storage clouds, and the like. In one example embodiment, data store 924 includes one or more servers, databases (e.g., MySQL), and/or data warehouses. Data store 924 may include data associated with different networking system 920 users and/or client systems 930.

Client system 930 is generally a computer or computing device including functionality for communicating (e.g., remotely) over a computer network. Client system 930 may be a desktop computer, laptop computer, personal digital assistant (PDA), in- or out-of-car navigation system, smart phone or other cellular or mobile phone, or mobile gaming device, among other suitable computing devices. Client system 930 may execute one or more client applications, such as a web browser (e.g., Microsoft Internet Explorer, Mozilla Firefox, Apple Safari, Google Chrome, and Opera), to access and view content over a computer network. In particular embodiments, the client applications allow a user of client system 930 to enter addresses of specific network resources to be retrieved, such as resources hosted by networking system 920. These addresses can be uniform resource locators (URLs) and the like. In addition, once a page or other resource has been retrieved, the client applications may provide access to other pages or records when the user “clicks” on hyperlinks to other resources. By way of example, such hyperlinks may be located within the webpages and provide an automated way for the user to enter the URL of another page and to retrieve that page.

A webpage or resource embedded within a webpage, which may itself include multiple embedded resources, may include data records, such as plain textual information, or more complex digitally encoded multimedia content, such as software programs or other code objects, graphics, images, audio signals, videos, and so forth. One prevalent markup language for creating webpages is HTML. Other common web browser-supported languages and technologies include XML, the Extensible Hypertext Markup Language (XHTML), JavaScript, Flash, ActionScript, Cascading Style Sheet (CSS), and, frequently, Java. By way of example, HTML enables a page developer to create a structured document by denoting structural semantics for text and links, as well as images, web applications, and other objects that can be embedded within the page. Generally, a webpage may be delivered to a client as a static document; however, through the use of web elements embedded in the page, an interactive experience may be achieved with the page or a sequence of pages. During a user session at the client, the web browser interprets and displays the pages and associated resources received or retrieved from the website hosting the page, as well as, potentially, resources from other websites.

When a user at a client system 930 desires to view a particular webpage (hereinafter also referred to as target structured document) hosted by networking system 920, the user's web browser, or other document rendering engine or suitable client application, formulates and transmits a request to networking system 920. The request generally includes a URL or other document identifier as well as metadata or other information. By way of example, the request may include information identifying the user, such as a user ID, as well as information identifying or characterizing the web browser or operating system running on the user's client computing device 930. The request may also include location information identifying a geographic location of the user's client system or a logical network location of the user's client system 930. The request may also include a timestamp identifying when the request was transmitted.

Although the example network environment described above and illustrated in FIG. 9 is described with respect to social networking system 920a and game networking system 920b, this disclosure encompasses any suitable network environment using any suitable systems. As an example and not by way of limitation, the network environment may include online media systems, online reviewing systems, online search engines, online advertising systems, or any combination of two or more such systems.

FIG. 10 illustrates an example computing system architecture, which may be used to implement a server 922 or a client system 930 (FIG. 9.) In one embodiment, hardware system 1000 comprises a processor 1002, a cache memory 1004, and one or more executable modules and drivers, stored on a tangible computer readable medium, directed to the functions described herein. Additionally, hardware system 1000 may include a high performance input/output (I/O) bus 1006 and a standard I/O bus 1008. A host bridge 1010 may couple processor 1002 to high performance I/O bus 1006, whereas I/O bus bridge 1012 couples the two buses 1006 and 1008 to each other. A system memory 1014 and one or more network/communication interfaces 1016 may couple to bus 1006. Hardware system 1000 may further include video memory (not shown) and a display device coupled to the video memory. Mass storage 1018 and I/O ports 1020 may couple to bus 1008. Hardware system 1000 may optionally include a keyboard, a pointing device, and a display device (not shown) coupled to bus 1008. Collectively, these elements are intended to represent a broad category of computer hardware systems, including but not limited to general purpose computer systems based on the x86-compatible processors manufactured by Intel Corporation of Santa Clara, California, and the x86-compatible processors manufactured by Advanced Micro Devices (AMD), Inc., of Sunnyvale, Calif., as well as any other suitable processor.

The elements of hardware system 1000 are described in greater detail below. In particular, network interface 1016 provides communication between hardware system 1000 and any of a wide range of networks, such as an Ethernet (e.g., IEEE 802.3) network, a backplane, and the like. Mass storage 1018 provides permanent storage for the data and programming instructions to perform the above-described functions implemented in servers 922 (FIG. 9), whereas system memory 1014 (e.g., DRAM) provides temporary storage for the data and programming instructions when executed by processor 1002. I/O ports 1020 are one or more serial and/or parallel communication ports that provide communication between additional peripheral devices, which may be coupled to hardware system 1000.

Hardware system 1000 may include a variety of system architectures, and various components of hardware system 1000 may be rearranged. For example, cache 1004 may be on-chip with processor 1002. Alternatively, cache 1004 and processor 1002 may be packed together as a “processor module,” with processor 1002 being referred to as the “processor core.” Furthermore, certain embodiments of the present disclosure may not require nor include all of the above components. For example, the peripheral devices shown coupled to standard I/O bus 1008 may couple to high performance I/O bus 1006. In addition, in some embodiments, only a single bus may exist, with the components of hardware system 1000 being coupled to the single bus. Furthermore, hardware system 1000 may include additional components, such as additional processors, storage devices, or memories.

An operating system manages and controls the operation of hardware system 1000, including the input and output of data to and from software applications (not shown). The operating system provides an interface between the software applications being executed on the system and the hardware components of the system. Any suitable operating system may be used, such as the LINUX Operating System, the Apple Macintosh Operating System, available from Apple Computer Inc. of Cupertino, Calif., UNIX operating systems, Microsoft(r) Windows(r) operating systems, BSD operating systems, and the like. Of course, other embodiments are possible. For example, the functions described herein may be implemented in firmware or on an application-specific integrated circuit (ASIC).

Furthermore, the above-described elements and operations can be comprised of instructions that are stored on non-transitory storage media. The instructions can be retrieved and executed by a processing system. Some examples of instructions are software, program code, and firmware. Some examples of non-transitory storage media are memory devices, tape, disks, integrated circuits, and servers. The instructions are operational when executed by the processing system to direct the processing system to operate in accord with the disclosure. The term “processing system” refers to a single processing device or a group of inter-operational processing devices. Some examples of processing devices are integrated circuits and logic circuitry. Those skilled in the art are familiar with instructions, computers, and storage media.

### Modules, Components, and Logic

Certain embodiments are described herein as including logic or a number of components, modules, or mechanisms. Modules may constitute either software modules (e.g., code embodied (1) on a non-transitory machine-readable medium or (2) in a transmission signal) or hardware-implemented modules. A hardware-implemented module is a tangible unit capable of performing certain operations and may be configured or arranged in a certain manner. In example embodiments, one or more computer systems (e.g., a standalone, client or server computer system) or one or more processors may be configured by software (e.g., an application or application portion) as a hardware-implemented module that operates to perform certain operations as described herein.

In various embodiments, a hardware-implemented module may be implemented mechanically or electronically. For example, a hardware-implemented module may comprise dedicated circuitry or logic that is permanently configured (e.g., as a special-purpose processor, such as a field programmable gate array (FPGA) or an ASIC) to perform certain operations. A hardware-implemented module may also comprise programmable logic or circuitry (e.g., as encompassed within a general-purpose processor or other programmable processor) that is temporarily configured by software to perform certain operations. It will be appreciated that the decision to implement a hardware-implemented module mechanically, in dedicated and permanently configured circuitry, or in temporarily configured circuitry (e.g., configured by software) may be driven by cost and time considerations.

Accordingly, the term “hardware-implemented module” should be understood to encompass a tangible entity, be that an entity that is physically constructed, permanently configured (e.g., hardwired) or temporarily or transitorily configured (e.g., programmed) to operate in a certain manner and/or to perform certain operations described herein. Considering embodiments in which hardware-implemented modules are temporarily configured (e.g., programmed), each of the hardware-implemented modules need not be configured or instantiated at any one instance in time. For example, where the hardware-implemented modules comprise a general-purpose processor configured using software, the general-purpose processor may be configured as respective different hardware-implemented modules at different times. Software may accordingly configure a processor, for example, to constitute a particular hardware-implemented module at one instance of time and to constitute a different hardware-implemented module at a different instance of time.

Hardware-implemented modules can provide information to, and receive information from, other hardware-implemented modules. Accordingly, the described hardware-implemented modules may be regarded as being communicatively coupled. Where multiple of such hardware-implemented modules exist contemporaneously, communications may be achieved through signal transmission (e.g., over appropriate circuits and buses) that connect the hardware-implemented modules. In embodiments in which multiple hardware-implemented modules are configured or instantiated at different times, communications between such hardware-implemented modules may be achieved, for example, through the storage and retrieval of information in memory structures to which the multiple hardware-implemented modules have access. For example, one hardware-implemented module may perform an operation, and store the output of that operation in a memory device to which it is communicatively coupled. A further hardware-implemented module may then, at a later time, access the memory device to retrieve and process the stored output. Hardware-implemented modules may also initiate communications with input or output devices, and can operate on a resource (e.g., a collection of information).

The various operations of example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions. The modules referred to herein may, in some example embodiments, comprise processor-implemented modules.

Similarly, the methods described herein may be at least partially processor-implemented. For example, at least some of the operations of a method may be performed by one or processors or processor-implemented modules. The performance of certain of the operations may be distributed among the one or more processors, not only residing within a single machine, but deployed across a number of machines. In some example embodiments, the processor or processors may be located in a single location (e.g., within a home environment, an office environment or as a server farm), while in other embodiments the processors may be distributed across a number of locations.

The one or more processors may also operate to support performance of the relevant operations in a “cloud computing” environment or as a “software as a service” (SaaS). For example, at least some of the operations may be performed by a group of computers (as examples of machines including processors), with these operations being accessible via a network (e.g., the Internet) and via one or more appropriate interfaces (e.g., Application Program Interfaces (APIs).)

### Miscellaneous

One or more features from any embodiment may be combined with one or more features of any other embodiment without departing from the scope of the disclosure.

A recitation of “a,” “an,” or “the” is intended to mean “one or more” unless specifically indicated to the contrary.

The present disclosure encompasses all changes, substitutions, variations, alterations, and modifications to the example embodiments herein that a person having ordinary skill in the art would comprehend. Similarly, where appropriate, the appended claims encompass all changes, substitutions, variations, alterations, and modifications to the example embodiments herein that a person having ordinary skill in the art would comprehend.

For example, the methods described herein may be implemented using hardware components, software components, and/or any combination thereof. By way of example, while embodiments of the present disclosure have been described as operating in connection with a networking website, various embodiments of the present disclosure can be used in connection with any communications facility that supports web applications. Furthermore, in some embodiments the term “web service” and “website” may be used interchangeably and additionally may refer to a custom or generalized API on a device, such as a mobile device (e.g., a cellular phone, smart phone, personal GPS, personal digital assistant, personal gaming device), that makes API calls directly to a server. The specification and drawings are, accordingly, to be regarded in an illustrative rather than a restrictive sense. It will, however, be evident that various modifications and changes may be made thereunto without departing from the broader spirit and scope of the disclosure as set forth in the claims and that the disclosure is intended to cover all modifications and equivalents within the scope of the following claims.

1. A computer-implemented method comprising:
in an automated operation performed using an overview display module comprising circuitry. configured to perform the automated operation, displaying an overview of a virtual world for a game instance of a multiplayer online game, the virtual world being defined by a virtual building having multiple rooms, the overview comprising an elevational view in which respective interiors of the multiple rooms are simultaneously visible;
receiving player input that indicates selection of a particular one of the multiple rooms; and
in an automated procedure performed responsive to the input and performed using a room view module comprising circuitry configured to perform the automated procedure, displaying on an enlarged scale relative to the overview a close-up view of the interior of the selected room, the close-up view showing a virtual three-dimensional space that is accessible to one or more player characters by animated movement in a lateral dimension and in a depth dimension relative to a close-up camera position from which the close-up view is shown.

2. The method of claim 1, further comprising limiting expansion of the virtual building during gameplay to addition of rooms that have at least one edge that lies in a vertical plane common to the multiple rooms arrangement, the overview being shown side-on to the common vertical plane.

3. The method of claim 1, wherein the interiors of the multiple rooms are bounded by a common laterally extending vertical front wall substantially perpendicular to an overview camera position from which the overview is shown, the common from wall being omitted in the overview, so that each of the multiple rooms appears to have an open side facing the overview camera position.

4. The method of claim 3, wherein the close-up view of the selected room comprises a perspective view through the open side of the selected room.

5. The method of claim 4, wherein the close-up view of the selected room comprises in linear perspective, the close-up camera position and a vanishing point of the perspective view being such that respective interior surfaces of two opposite, parallel side walls are simultaneously visible in the close-up view.

6. The method of claim 5, wherein at least one of the side walls has a doorway leading to an adjacent room, at least part of an interior of the adjacent room being visible through the doorway in the close-up view of the selected room.

7. The method of claim 6, further comprising, responsive to user input, showing animated movement of a player character from the selected room to the adjacent room, and automatically animating to a close-up view of the adjacent room.

8. The method of claim 5, wherein the close-up camera position and the vanishing point are located centrally in the lateral dimension of the selected room.

9. The method of claim 4, wherein the close-up view of the selected room comprises a linear perspective, the close-up camera position and a vanishing point of the perspective you being such a ceiling surface and a floor surface of the selected room are simultaneously visible in the close-up view.

10. Tile method of claim 4, further comprising shifting camera focus in the close-up view by swiveling camera direction while the close-up camera position remains mostly fixed.

11. The method of claim 10, further comprising swiveling camera direction both horizontally and vertically.

12. The method of claim 10, further comprising automatically shifting camera direction to a focus game element in the selected room, responsive to player interaction with the focus game element.

13. The method of claim 12, further comprising automatically zooming in on the focus game element responsive to shifting camera direction to it.

14. The method of claim 4, further comprising, responsive to player interaction with a focus game element, automatically rendering the focus game element in an increased size.

15. A system comprising:
an overview display module comprising circuitry configured to display an overview of a virtual world for a game instance of a multiplayer online game, the virtual world being defined by a virtual building having multiple rooms, the overview comprising an elevational view in which respective interiors of the multiple rooms are simultaneously visible;
a graphical user interface module configured to receive player input that indicates selection of a particular one of the multiple rooms; and
a room view module comprising circuitry configured to display, responsive to the input, a close-up view of the interior of the selected room on an enlarged scale relative to the overview, the close-up view showing a virtual three-dimensional space that is accessible to one or more player characters by animated movement in a lateral dimension and in a depth dimension relative to a close-up camera position from which the close-up view is shown.

16. The system of claim 15, further comprising limiting expansion of the virtual building during gameplay to addition of rooms that have at least one edge that lies in a vertical plane common to the multiple rooms arrangement, the overview being shown side-on to the common vertical plane.

17. The system of claim 15, wherein the interiors of the multiple rooms are bounded by a common laterally extending vertical front wall substantially perpendicular to an overview camera position from which the overview is shown, the common front wall being omitted in the overview, so that each of the multiple rooms appears to have an open side facing the overview camera position.

18. The system of claim 17, wherein the close-up view of the selected room comprises a perspective view through the open side of the selected room.

19. The system of claim 18, wherein the close-up view of the selected room comprises a linear perspective, the close-up camera position and a vanishing point of the perspective view being such that respective interior surfaces of two opposite, parallel side walls are simultaneously visible in the close-up view.

20. The system of claim 19, wherein at least one of the side walls has a doorway leading to an adjacent room, at least part of an interior of the adjacent room being visible through the doorway in the close-up view of the selected room.

21. The system of claim 20, further comprising, responsive to user input, showing animated movement of a player character from the selected room to the adjacent room, and automatically switching to a close-up view of the adjacent room.

22. The system of claim 19, wherein the close-up camera position and the vanishing point are located centrally in the lateral dimension of the selected room.

23. The system of claim 18, wherein the close-up view of the selected room comprises a linear perspective view, the close-up camera position and a vanishing point of the perspective view being such that a ceiling surface and a floor surface of the selected room are simultaneously visible in the close-up view.

24. The system of claim 18, further comprising shifting camera focus in the close-up view by swiveling camera direction while the close-up camera position remains mostly fixed.

25. The system of claim 24, further comprising swiveling camera direction both horizontally and vertically.

26. The system of claim 15, further comprising automatically shifting camera focus to a focus game element in the selected room, responsive to player interaction with the focus game element.

27. The system of claim 26, further comprising automatically zooming in on the focus game element responsive to shifting camera focus to it.

28. The system of claim 18, further comprising, responsive to player interaction with a focus game element, automatically rendering the focus game element in an increased size.

29. A mobile electronic device that comprises:
a screen; and
a game display
module comprising circuitry configured to
display on the screen an overview of a virtual world for a game instance of a multiplayer online game, the virtual world being defined by a virtual building having multiple rooms, the overview comprising an elevational view in which respective interiors of the multiple rooms are simultaneously visible;
receive player input that indicates selection of a particular one of the multiple rooms; and
responsive to the input, display on the screen, to an enlarged scale relative to the overview, a close-up view of the interior of the selected room, the close-up view showing a virtual three-dimensional space that is accessible to one or more player characters by animated movement in a lateral dimension and in a depth dimension relative to a close-up camera position from which the close-up view is shown.

30. The mobile electronic device of claim 29, wherein the screen is touch sensitive, the user input being received via the screen.

31. A non-transitory machine-readable storage device storing instructions which, when performed by a machine, causes the machine to:
display an overview of a virtual world for a game instance of a multiplayer online game, the virtual world being defined by a virtual building having multiple rooms, the overview comprising an elevational view in which respective interiors of the multiple rooms are simultaneously visible;
receive player input that indicates selection of a particular one of the multiple rooms; and
responsive to the input display on an enlarged scale relative to the overview a close-up view of the interior of the selected room, the close-up view showing a virtual three-dimensional space that is accessible to one or more player characters by animated movement in a lateral dimension and in a depth dimension relative to a close-up camera position from which the close-up view is shown.
